(19) United States
(12) Patent Application Publication
(10) Pub. No.: US 2017/0026456 A1
(43) Pub. Date: Jan. 26, 2017

(54) File Tagging and Sharing Systems

(71) Applicant: Wox, Inc., Brooklyn, NY (US)

(72) Inventor: Seth Adam Hillinger, Brooklyn, NY (US)

(21) Appl. No.: 15/218,942

(22) Filed: Jul. 25, 2016

Related U.S. Application Data
(60) Provisional application No. 62/196,199, filed on Jul. 23, 2015.

(51) Int. Cl. H04L 29/08

(52) U.S. Cl. CPC H04L 67/06; H04L 67/18; H04L 67/02

(57) ABSTRACT

A music sharing system that links an audio file to a location, and to music sharing systems that permit a first user to associate an audio file with a particular location, and share this information with a second user.

### BACKGROUND

With the invention of recorded music, came a change in how it was consumed. No longer did the listener need to be in the same physical location as the artist. Although live music is still the purest way to experience music, as recorded music evolved, the relationship between artist, listener and place devalued the importance of location, in favor of portability. Consciously or not, musicians today still create music with a place in mind. There is a deep connection created in our brains that correlate place with a sensory experience. Whether it's the hickory smoked taste of BBQ in Texas, the salty fresh smell of a beach in Cape Cod, or the rhythm of a bucket drummer in a New York Subway station, a memory imprint is made. This memory doesn't just record the taste, smell, or sound, but also associates it to a time, place, and people you were with.

### SUMMARY OF THE DISCLOSED TECHNOLOGY

Radio was once a means of discovering musical content within a specific city or location. With the advent of streaming music, local musical content is not readily discovered as users program their devices to deliver specific music genres whenever and wherever the user desires. Streaming music typically does not place any significance on location.

The disclosed technology returns the significance of location specificity that is currently lost. That is, the disclosed technology returns the context of place to music and uses location enabled hardware to control where a piece of music is listened to. The disclosed technology also returns the social and cultural significance of being physically together with other people when consuming music.

Specifically, the disclosed technology permits an audio memory to be captured digitally, much like a photo captures the visual experience. Users can share and discover other people's “audio memories” in a whole new way and celebrate our similarities and differences on a large scale.

The disclosed technology also creates a collective conscience, mapping an auditory world that was, until now, trapped inside our own memories. The disclosed technology can then use this data for artificial intelligence. This intelligence will be able to predict and suggest new information based on a listener's personal preferences, their location, and other factors like the time of day. This information can also be displayed in virtual reality hardware and can communicate via artificial bot messages.

In certain embodiments, the present technology is directed to a method of linking an audio file to a location, the method comprising the steps of: creating, through a computer server and a navigation or location system, a record of a first user's presence in the location; and associating, through a computer server, the audio file with the location of a drop created by the first user; wherein access to the drop is available to a second user whenever the second user is within a certain distance of the location.

In certain embodiments, the present technology is directed to a music sharing system comprising: a processor configured to record information about a location and identity of a first user, and to associate the information and identity with an audio file selected by the user to link to the location; and a memory in communication with the server and configured to store the information, wherein the information can be accessed by a second user when the second user is within a certain distance of the location.

### BRIEF DESCRIPTION OF DRAWINGS

The features, aspects and advantages of the disclosed technology will become better understood with regard to following description and accompanying drawings, wherein like reference numerals refer to similar parts throughout the several views where:

FIG. 1 is an illustration of a music sharing environment of the disclosed technology;

FIG. 2 is flow diagram showing a flow of data for the disclosed technology;

FIG. 3 is an illustration of a user interface for the disclosed;

FIG. 4 is an illustration of a music sharing environment of the disclosed technology;

FIG. 5 is an illustration of a user interface for the disclosed technology;

FIG. 6 is flow diagram showing a flow of data for the disclosed technology;

FIG. 7 is flow chart for discovering dropped content based on location for the disclosed technology;

FIG. 8 is an illustration of a music sharing environment of the disclosed technology;

FIG. 9 is an illustration of a user interface for the disclosed;

FIG. 10 is an illustration of a user interface for the disclosed;

FIG. 11 is an illustration of a user interface for the disclosed;

FIG. 12 is flow chart for remotely creating a sponsored drop for the disclosed technology;

FIG. 13 is flow chart for automating a drop recommendation for the disclosed technology;

FIG. 14 is flow chart for notifying users of drop recommendations for the disclosed technology;

FIG. 15 is an illustration of a user interface for the disclosed;

FIG. 16 is an illustration of a user interface for the disclosed; and

FIG. 17 is an illustration of a user interface for the disclosed.

### GLOSSARY OF TERMS

Audio, Audio file, Audio memory: recorded sound file, but used herein to also denote multimedia files or any type of electronic data file.

Geofence: A geofence is a defined region. It typically refers to the longitude and latitude, but it is not limited to that alone. Below are three forms in which a geofence can be defined:

(1) Longitude and Latitude accessed via the global positioning system (GPS) hardware on a mobile device. This can be very accurate as long as there is limited interference.

(2) Cellular Radio towers. Less accurate but still good for creating a broader region using triangulation to determine longitude and latitude. This is also good for maintaining a mobile device's battery life because it does not require GPS.

(3) Bluetooth Low Energy (BLE) transmitters broadcast a radio frequency and enable geofences to be created based on near-field proximity to the transmitter. These are very accurate.

Point: A geofence reference to a precise location, a name for that location, an optional order index as it relates to other points, and a radius for the size of the fence.

Track: A track is a reference to song or any audio file or piece of content, for example, a stream. It can include properties like title, artist, album, stream source, release date, description, index, and whether it's downloadable.

User: A User (also referred to herein as a “Listener” or “Curator”) is someone currently interacting with the software application.

Drop: A drop is the combination of a point, a track, and the user who created it. A point and a track are decoupled and have no direct reference to each other. The Drop is the virtual object that users create and collect.

Place: A group of points within a specific radius.

Playlist: A group of tracks organized by a user.

Users: A group of users.

Sets: A group of drops created by a one or many user.

Collection: A history of drops created by a single user. Each drop is accessible to the user once they've discovered it.

### DETAILED DESCRIPTION

Music and multimedia are languages that have the power to unlock emotions buried in our subconscious. The disclosed technology helps people better understand themselves, their surroundings, and the larger cultural connections that exist thanks to the more connected world that we now live in. By doing so, we will create a more empathetic, cohesive, and peaceful world to live in.

The methods and systems of the present technology are, in certain embodiments, directed to the following concepts: A first user can create a Playlist, in which he includes audio or other types of files (including, but not limited to, musical tracks). Upon finding himself in a certain location, the first user can associate an audio file and his identifying information with that location. In certain embodiments, he can associate more than one audio file with a location, or move to a different location and “tag” another audio file. Each point created in this manner can be referred to as a “Drop.” In certain embodiments, the first user can be referred to as a “Curator” as he can develop expertise in a particular al area; for example, a park, public space, business location or the like. In such cases, subsequent users may look to the Curator as someone having particular familiarity or expertise in the location. The Curator can have his identity associated with one or more of his Drops—in various embodiments, a user name, an actual name, a graphical representation such as an avatar or a logo, or any other identifier. A curator can also be a musician wanting to share their music with fans. A curator can also be a brand looking to engage their customers in new ways. A curator can also be a reader of an audiobook, guiding it's listeners through a mystery around the city. A curator can also be a tour guide, charging its customers per play.

In certain embodiments, a second user can access the first user's “Playlist History” for the location, by using the audio file to evoke a certain feeling or memory associated with the location. In various embodiments, the “Drops” can be fluid, in that the first user can change the information associated with a Drop or change the audio file associated therewith. There by making the Drop moveable and configurable.

The technology herein differs from known methods in many ways. For example, existing location-based audio services lack many features of the present technology. Among them are: a lack of user-generated content and the ability to be a “Curator” as a user, in that such services are created by the service itself via internal committee (as with a news or blog website where there is one source of data); do not include content streamed from a cloud or mobile (or other wireless) functionality; and do not permit desktop computer access.

Various embodiments of the methods and systems of the present technology are described below.

In a first implementation, a user can save a geolocation point along with a reference to a music file/track and create a drop. This can be either a cloud based reference or a file that is downloadable. The point, the track and the drop can be saved in a database.

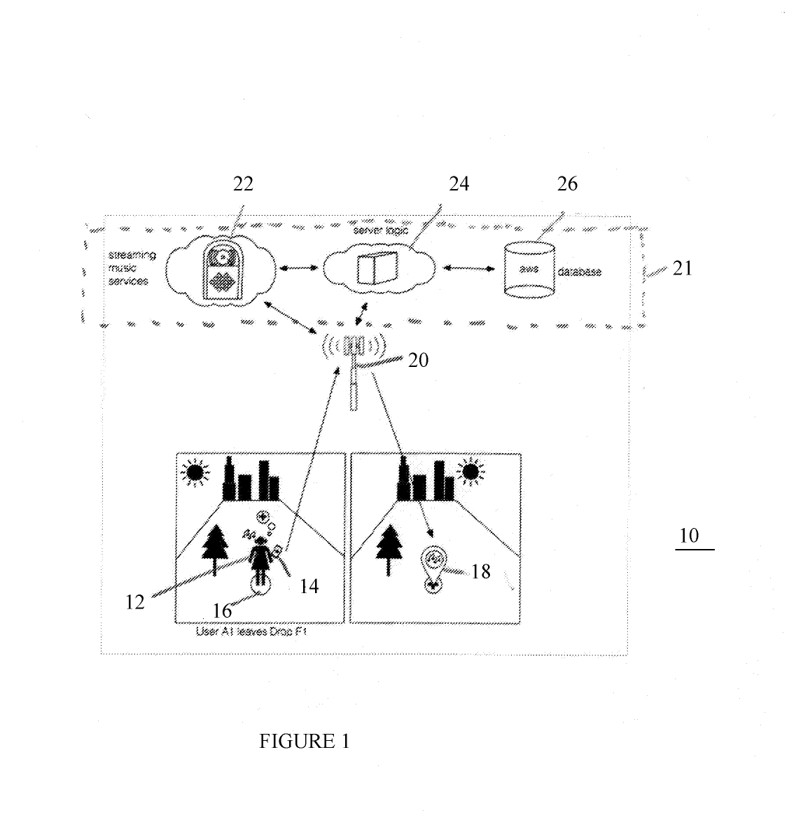

As shown in FIG. 1, a music sharing environment 10 can include a user 12, a mobile device 14 running a music sharing application and a transceiver 20 being linked between the mobile device 14 and a backend server 21. The backend server 21 can include a streaming music server 22, a logic server 24 and database 26. In use, a user 12 can create a playlist on the mobile device 14. The user 12 can then associate the playlist with a real-time or near real-time geolocation. The playlist and geolocation can be transmitted to a backend logic server 24 associated with the music sharing application. The logic server 24 then stores the playlist and geolocation as a drop 18 within the database 26. The drop 18 can be viewable by other users on their mobile devices as they approach the geolocation.

For example, a user can create a drop as described below:

User A1 is a curator of music Playlist B1 (for example, a playlist that User A1 has created from his favorite tracks of music) and lives in the region of Place C1.

User A1 is walking through the Central Park and marks their geolocation with Point D1.

User A1 is listening to Song E1, (Miles Davis, “Blue in Green”).

User A1 creates a Drop F1 consisting of Point D1 and Song E1.

Drop F1 is added to User A1's Set G1.

In another example, a user can create more drops as described below:

User A1 may choose to drop other Songs E2 and E3 (all of which exist within playlist B1).

Point D2 is associated with song E2, creating Drop F2.

Point D3 is associated with song E3, creating Drop F3.

Drops F2 and F3 are also added to Set G1.

Set G1 now contains 3 Drops, which can be accessed as a single collection by User A1 and available to other users to discover. Each of the aforementioned locations is thus tagged with a song and is now indirectly associated with user A1 and his/her Set G1

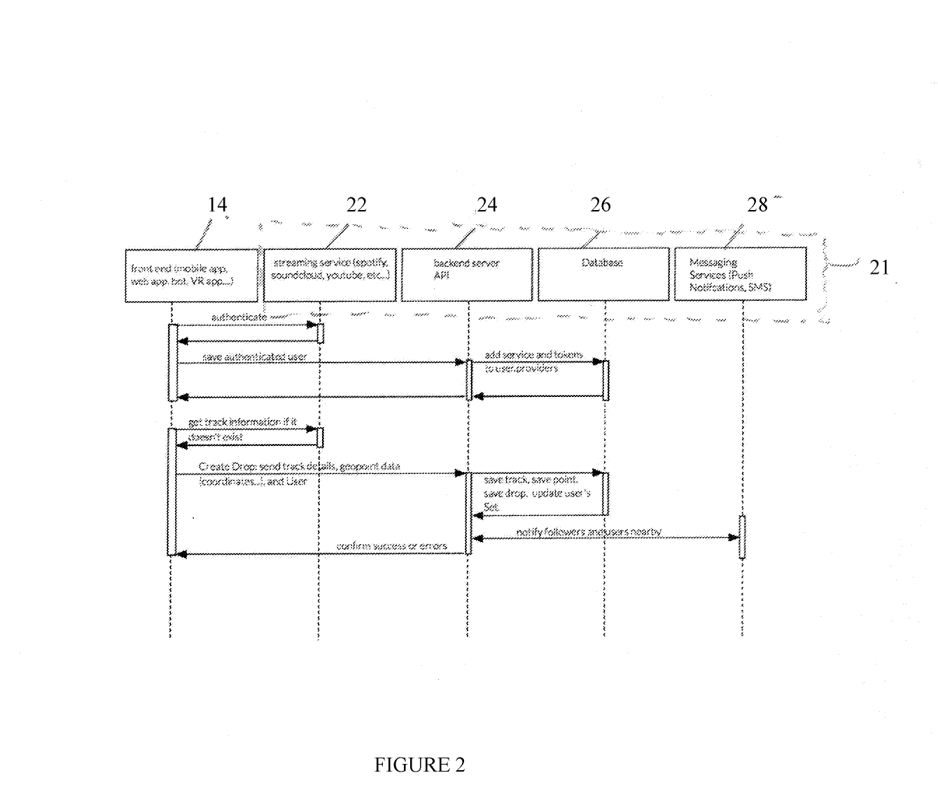

FIG. 2 illustrates the flow of data to from the front end device 14 to the backend server 21. The backend server 21 can further include a messaging service 28 for notifying users about drops near the user's location.

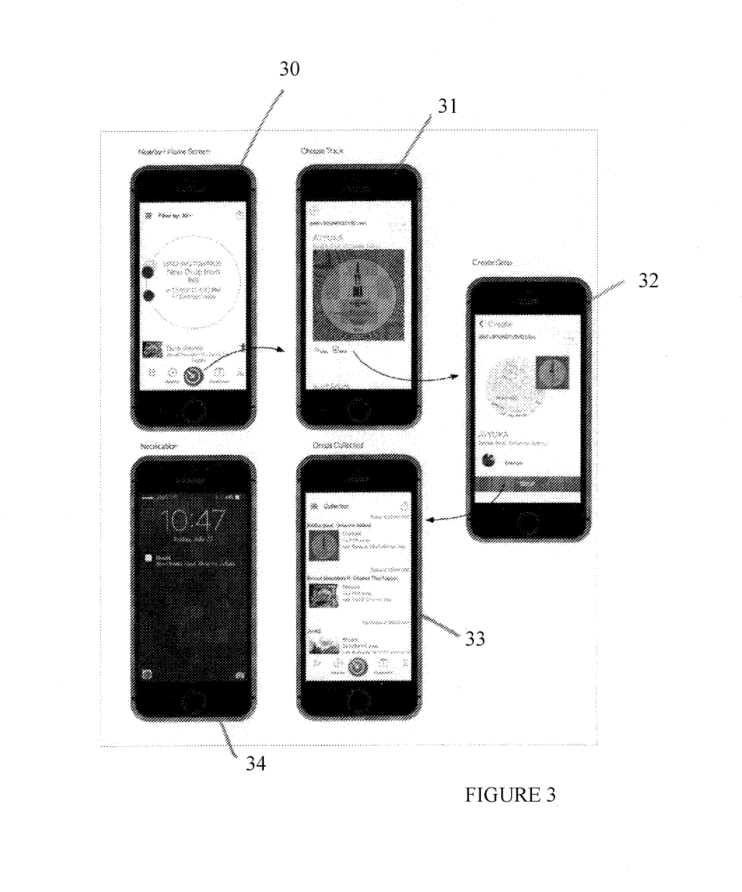

FIG. 3 illustrates an example of a user interface for the music sharing application on the mobile device. The various interfaces 30-34 show how a user can locate nearby drops.

In another implementation, a user can discover nearby drops or query for nearby drops. For example, User A2 is an avid enthusiast of new music discovery and new places. He/she is exploring a new hip area, lively with culture. As the application runs in the background, it will periodically query the user's location for points within a certain radius of a a1 location or area, for example, 1000 feet. When points are found, the application subsequently returns points D1, D2, and D3 as nearby points with drops. It will notify the user in in various ways, both in the foreground (when the app is open), and in the background (when the app is hidden). Additional examples of notifications include push messages when the device is locked, a chat bot message over SMS, an audio sound effect, visual notification like a popup message or a heads up display message if the user is wearing virtual reality eye wear.

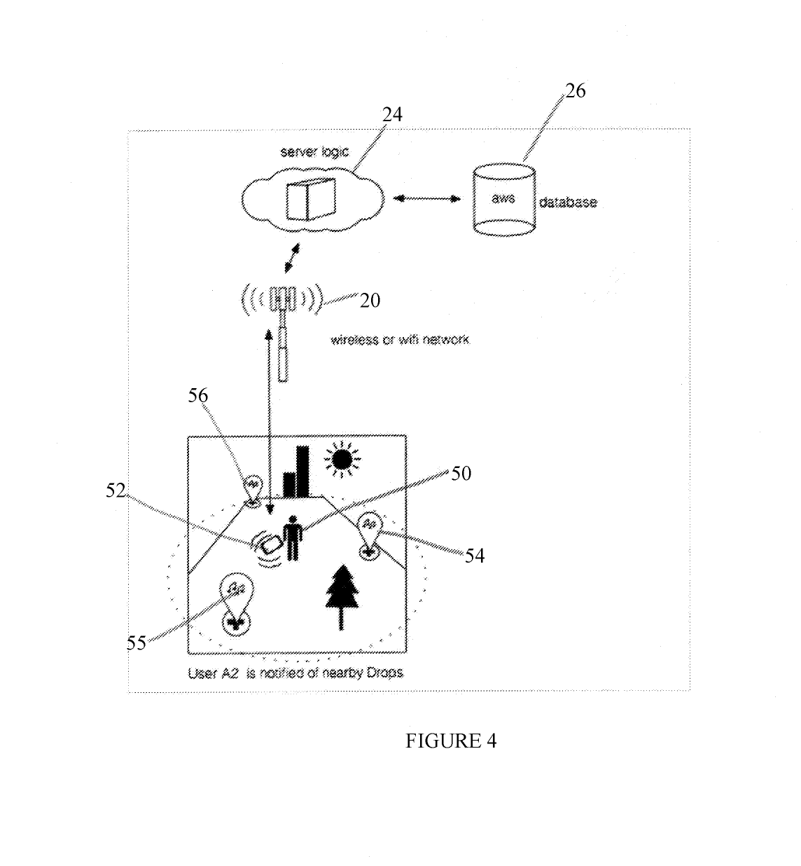

For example, as shown in FIG. 4, a user 50 can access the server logic 24 through a desktop computer (including a laptop computer) or a handheld device 52 (including, for example, a smart phone, a personal digital assistant, a tablet or any other computer device that can be carried around easily). The user 50 can then query the server 24 about nearby drops. The server 24 can query the database 26 and nearby drops 54-56 can be transmitted to the user 50.

In certain embodiments, a user can access the server logic through a desktop computer, and a second user (not shown) can access the information through a handheld device.

In another implementation, a user can discover drops that the user follows. In this scenario, the query to the server is filtered to only return drops made by users whom they “follow.” So rather than querying the complete database of drops, it queries only the drops made by other users with which the user has a relationship. As discussed above, in certain embodiments this means that a first user (or “Curator”) can develop a following of other users, who can access the sets that he has created. In addition, the user can select which followers to be notified. Meaning that the user can mute being notified about selected sets of drops. Thus making it easier to narrow the results being returned.

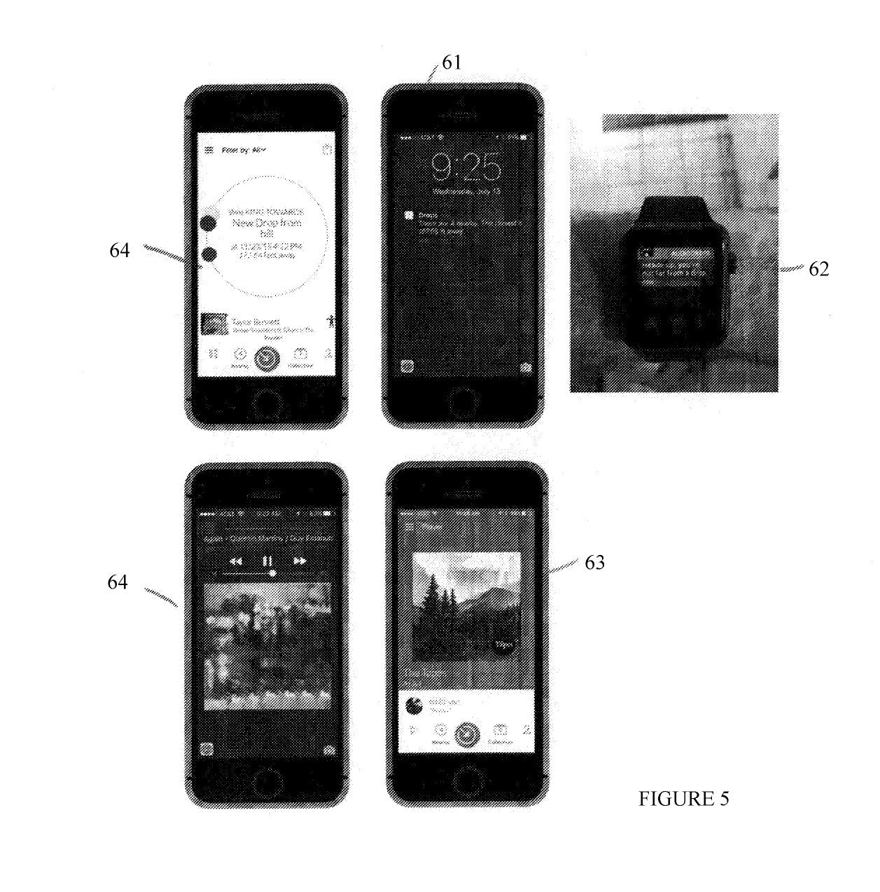

FIG. 5 illustrates an example of a user interface for the music sharing application on the mobile device. The various interfaces 60-64 show FIG. 5 describes an interface in which the user can view drops returned from a query.

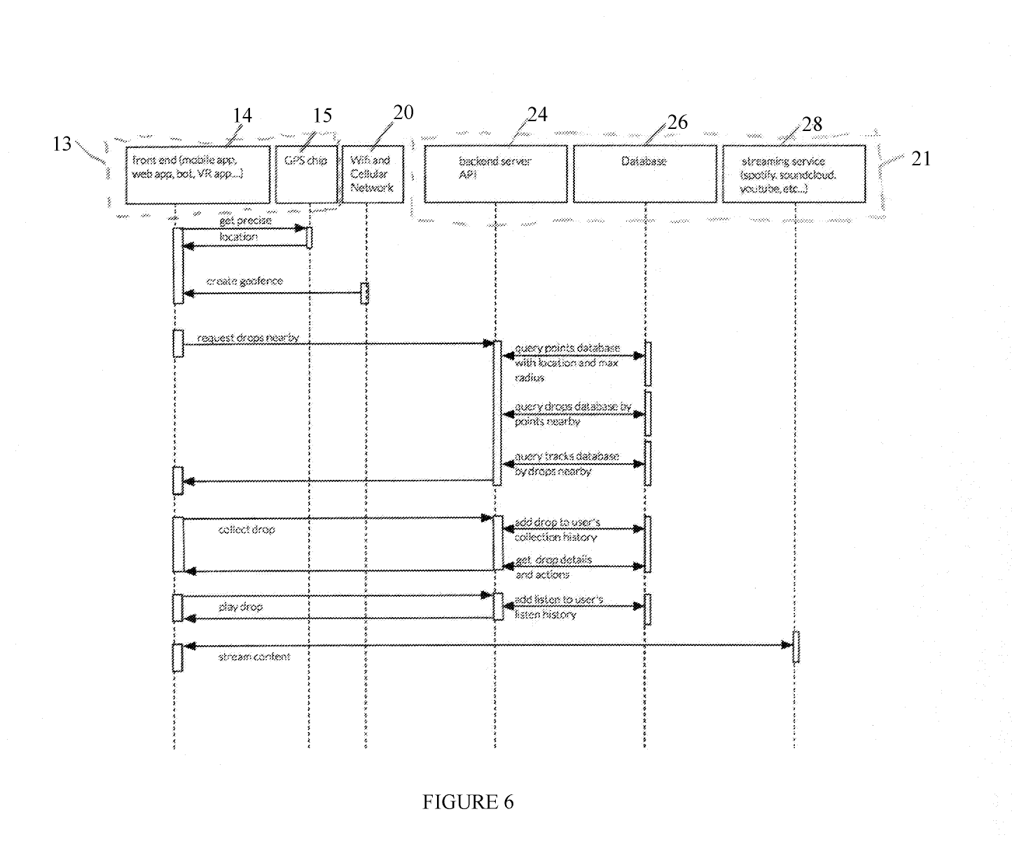

FIG. 6 illustrates the flow of data to from the front end device 13 to the backend server 21 for when querying for drops. The front end device 13 can include a GPS chip 15 for acquiring a location of the front end device 13.

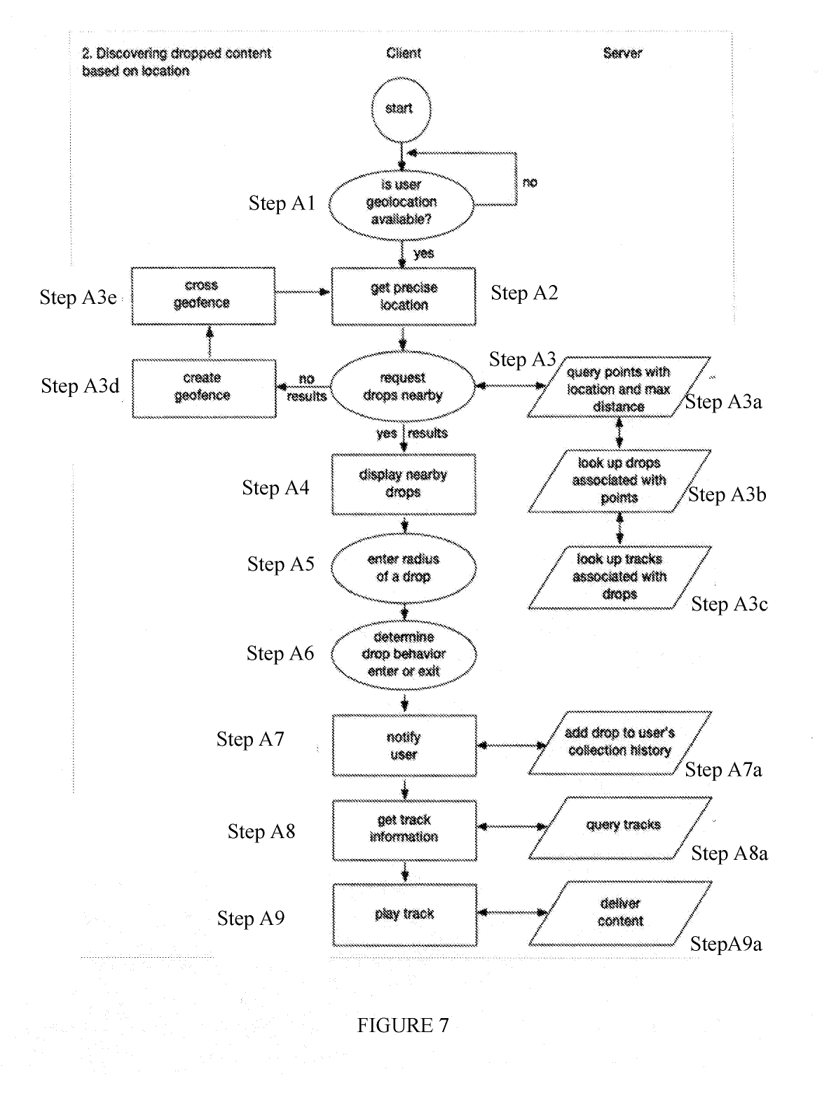

FIG. 7 illustrates an exemplary flow chart for querying nearby content or drops. At the start of the application, the system queries for a user geolocation, if available. Step A1. If no location is found, the system, once again, tries to establish a geolocation. If a geolocation is available, a precise location is established. Step A2. A user can then request to locate nearby drops. Step A3. Once requested, the system queries the server to find points within a location. Step A3a. Once a point is determined, drops associated with the points are found. Once the drops are found, the tracks associated with the drops are found. Step A3c. The drops are displayed on a user device. Step A4. (If no drops are found, a geofence is created Step A3d and as the user crosses the geofence Step A3e, the precise location of the user is sought. Step A2.) After the drops are displayed, the user can enter a radius of the drop. Step A5. The system can determine drop behavior. Step A6. The user is notified of the drop behavior. Step A7. (The drop can be added to the user's collection history. Step A7a.) The user is given the track information. Step A8. (Tracks can be queried. Step A8a.). The track is then played. Step A9. (Other content can be delivered. Step A9a).

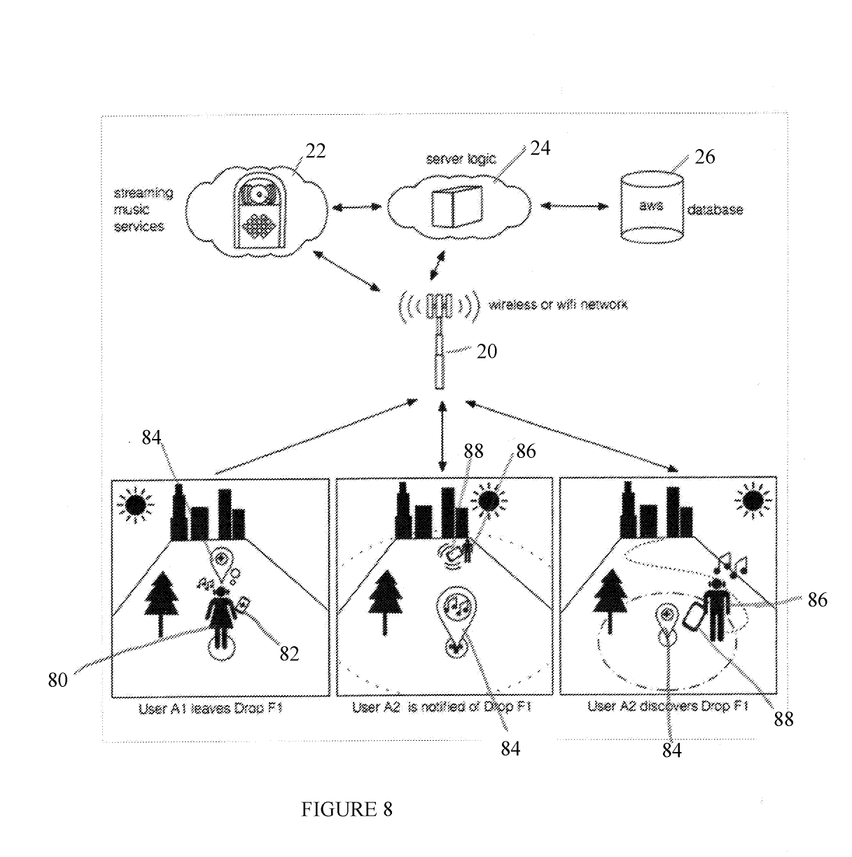

In another implementation, as shown in FIG. 8, a user 80 with device 82 can query all points related to a single set of drops. That is, User 86 with mobile device 88 can receive a private drop from User 80. In one example, User 86 and 80 are boyfriend and girlfriend. The girlfriend sends her the boyfriend a private drop 84 and he goes out of his way to discover what was left for him by her.

For example,

1. User A2 follows User A1.

2. User A1 sends User A2 an external message with a link to the drop details.

3. User A1 handles message and sets query to filter only Drops in User A1's Set.

4. User A2 travels to Point D2 and collects Drop F1

5. Drop F1 includes Song E2

6. Song E2 is added to User A2's Playlist H2

7. Drop F1 is added to User A2's Collection G2

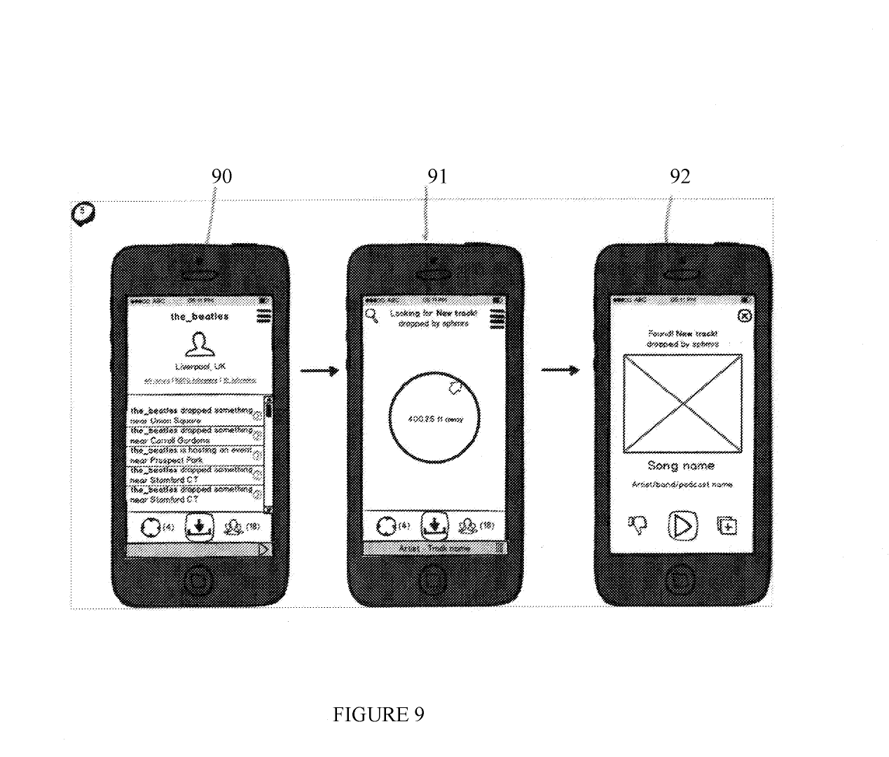

In another implementation, a user can view all points created by a particular person. FIG. 9 describes an interface 90-92 for the user to view all Drops made by another user via their profile. Upon doing so, the application queries the server filter by a single user and returns Drops F3 through F8.

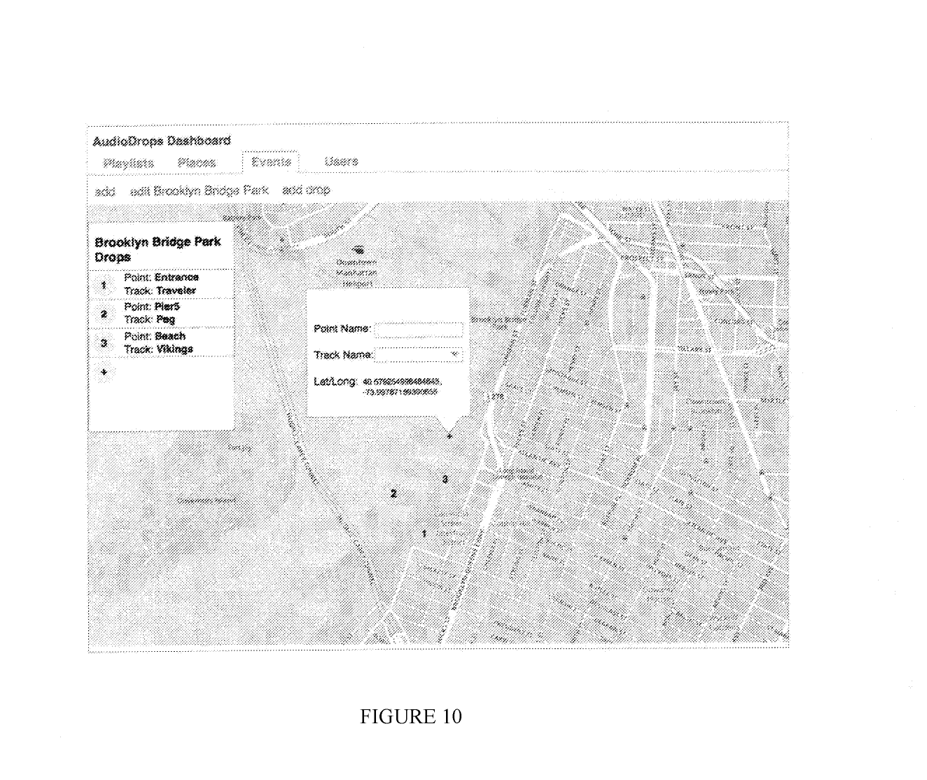

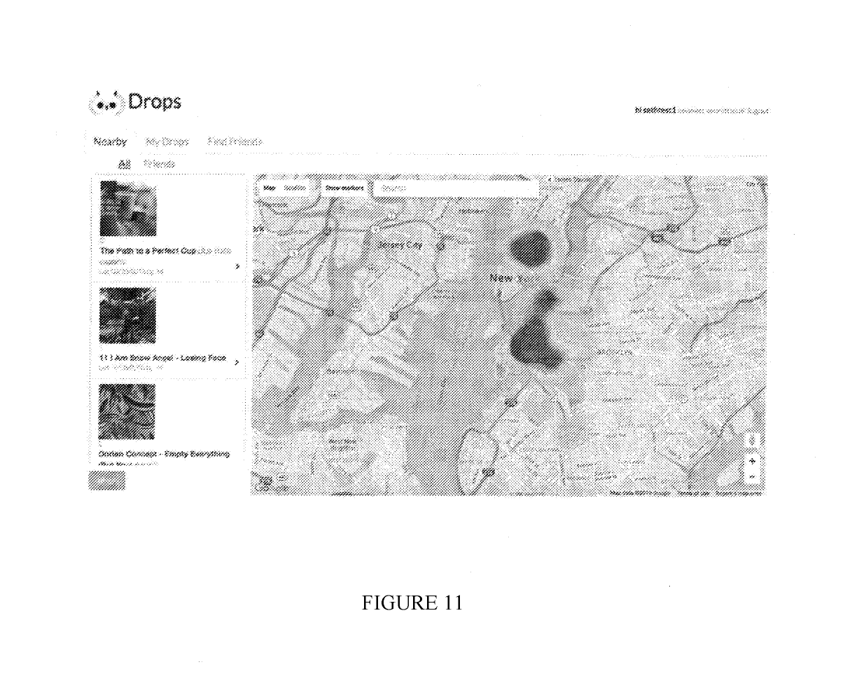

In another implementation, a sponsor can remotely set up drops. A “sponsored” Curator is a special User that can have the ability to add drops from a remote location. This is achieved by gaining access to a private CMS (content management system) which enables them to manage their Playlist, Locations and Sets. They will also have access to analytics about the usage of the Drops. FIG. 10 is an illustration of the CMS map for managing a Set of Drops. FIG. 11 is an illustration of a Sponsor map seeing Drop Analytics

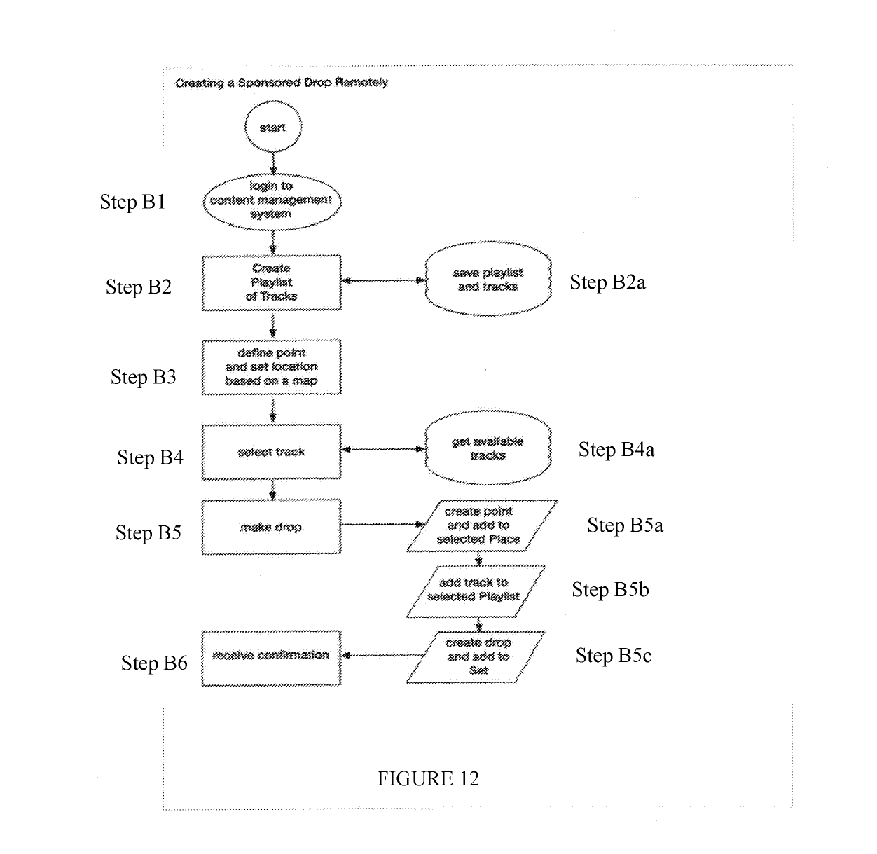

FIG. 12 illustrates an exemplary flow chart for creating a sponsored drop remotely. A user can log into a content management system (CMS). Step B1. The user creates a playlist. Step B2. The user defines a point and sets the point on a map. Step B3. The user selects a track, Step B4, and makes a drop on the map, Step B5. A confirmation is then received. Step B6. (During the drop, a user can create a point and add a selected place, Step B5a, add a track to a selected playlist, Step B5b, and create a drop and add to the User's set, Step B5c.)

In another implementation, the back end server can create a drop when none are found in a query. That is, when there aren't any drops nearby or the user has asked for a suggestion, the algorithm can create or update a drop with a new track. That is, the systems herein can “suggest” a drop, or can point the second user to a drop created by a different first user or curator.

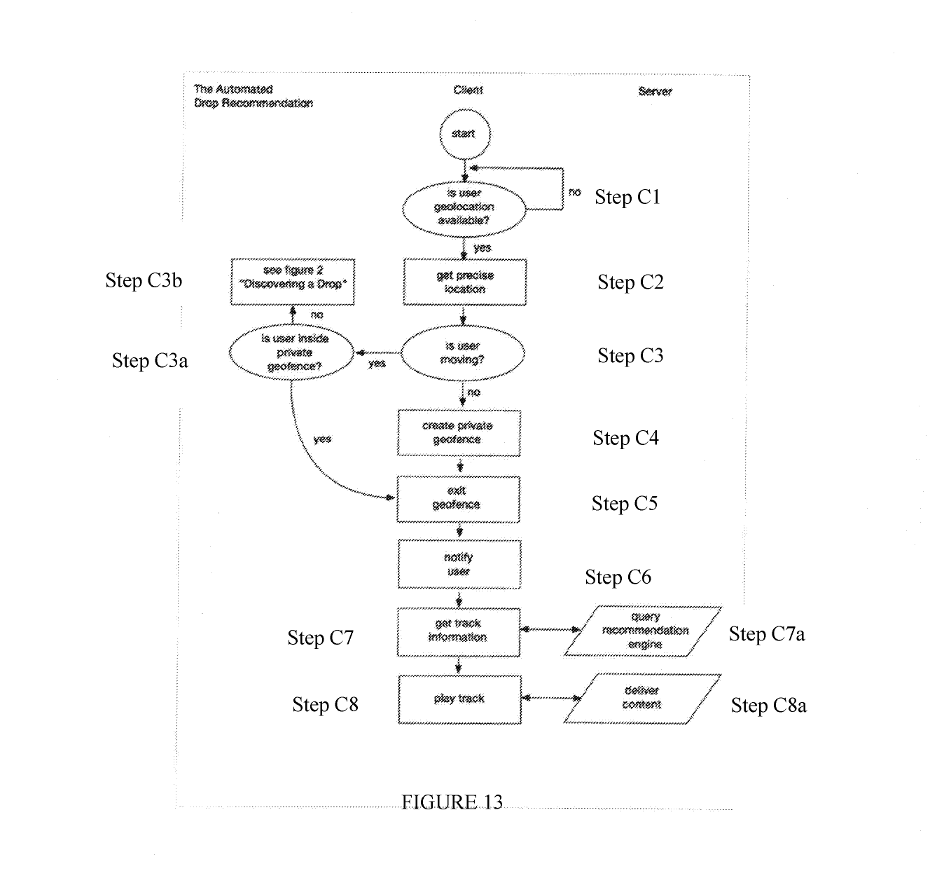

FIG. 13 illustrates an exemplary flow for automated drop recommendations. At the start of the application, the system queries for a user geolocation, if available. Step C1. If no location is found, the system tries to establish a geolocation. If a geolocation is available, a precise location is established. Step C2. The system then decides if the user is moving. Step C3. If yes, system decides if user is inside a private geofence. Step C3a. If no, a query for a drops is made. Step C3b. If yes, the system determined when the user exits the geofence. If the user is not moving, the system creates a private geofence Step C4, and determines when the user exits the geofence. Step C5. The user is notified of recommended drops. Step C6. Track information can be obtained. Step C7. The track is played. Step C8. Other content can be delivered Step C8a.

In another implementation, a user can receive notifications when new drops are created nearby. In certain embodiments, when a curator creates a new Drop, Users nearby can receive a notification that a new Drop was created near them. When a Drop is created, it is saved and available for discovery. The new Drop can be discovered via a new query but what about the users already within the radius of the creator? They will immediately be notified of the new Drop via Push Notification.

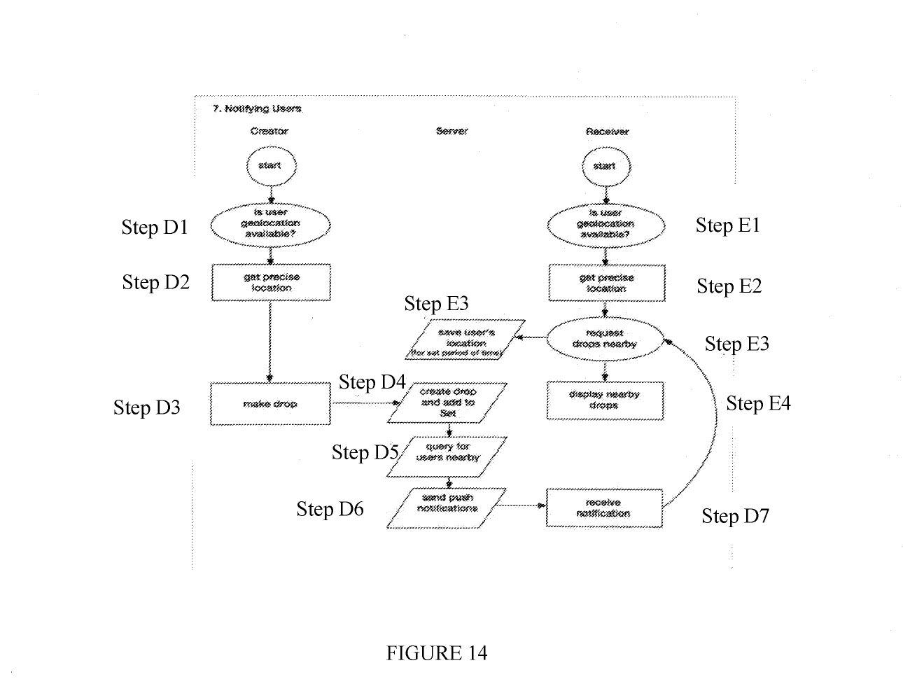

FIG. 14 illustrates an exemplary flow for notifying users. At the start of the application on a creator side, the system queries for the creator's geolocation. Step D1. A precise location is established. Step D2. The creator makes a drop. Step D3. The drop is added to creator's set Step D4, the creator can query for nearby drops Step D5, send push notifications Step D6 and receive notifications Step D7. On a receiver side, at the start of the application, the system queries for the receiver's geolocation. Step E1. A precise location is established. Step E2. The receiver requests nearby drops. Step E3. (A receiver's location can be saved. Step E3a.) The drops discovered are displayed. Step E4.

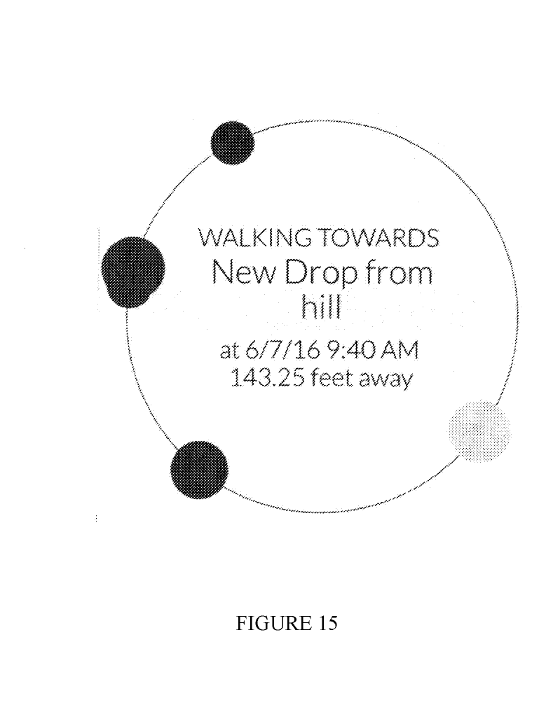

FIG. 15 describes a more sophisticated interface for a compass screen. The black circles represent Drops nearby and the triangle represents the User. The larger the circle, the closer the User is to the Point. As the User rotates their body 360 degrees, the circles rotate or orbit around the circle. The user can “select” A Drop target by clicking on the circle of interest User A1 is listening to Song E1, (Miles Davis, “Blue in Green”).

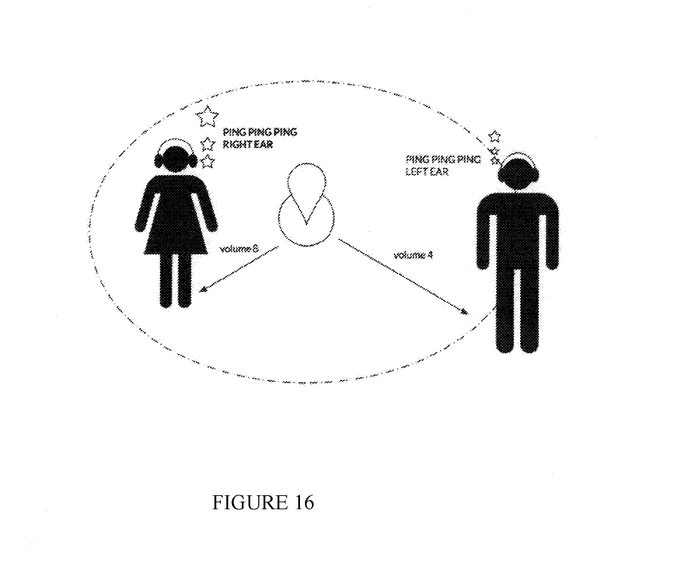

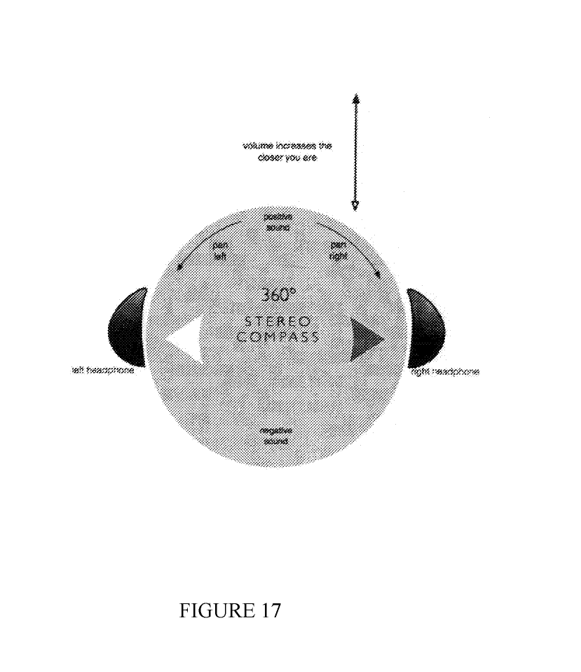

The embodiment, shown in FIGS. 16 and 17, are visual descriptions of an audio compass in accordance with certain embodiments herein. It requires the User to wear headphones. In FIG. 16, there are “clicking” sound effects that travel from your right ear to your left ear depending on the direction of the selected drop. When the target is in front, there is a positive sound effect. When the target is behind you, there is a negative sound effect. When the drop is further away, the sound is quieter. When the drop is closer, the sound is louder. In FIG. 17, if music is playing, when the drop is further away, the sound is quieter. When the drop is closer, the sound is louder.

In certain embodiments of the present technology, the Points and Tracks can be decoupled. This offers increased flexibility and the ability to update and modify Drops over time, and time is a differentiator. In a “loosely” coupled implementation typical of certain embodiments herein, the Curator (or recommendation engine) can update an existing point with a new track by modifying the Drop, leaving the geolocation untouched. By preserving the location, the User can maintain his history of locations without duplicates. Further, listeners will not be bombarded with choice fatigue.

In various embodiments herein, each “Drop” can contain one or more of the following: song metadata or location metadata. In certain embodiments, the song metadata and location metadata are not combined together—that is, the table for location metadata is separate from the table for song metadata. Thus, in certain embodiments, there is an additional “Sets” table of “Drops,” with each “Drop” containing a pointer to an audio metadata and location metadata.

In certain embodiments herein is the ability to auto-play audio without the user having to initiate the software application. This permits users to operate the software application in a hands-free manner.

In certain embodiments herein is the presence of a 360 degree audio compass to guide users to a location without having to take their phone out of their pocket.

Another differentiation in certain embodiments herein is that the geofence can be triggered upon exiting a radius, not just entering a radius. That is, in certain embodiments, when a User enters the presence of a Drop (in various embodiments, a radius of about 50 to about 200 feet, about 75 to about 150 feet or about 100 feet), this entrance can trigger the music to start playing. However, in other embodiments, the system is configured to start playing when the User exits the radius. For example, a User may desire to hear new music when leaving the home for work. In such a case, the User can configure the system to Trigger a song with instructions, e.g., “Play when I leave.” When the User exits the radius, the song plays.

Another differentiation is the ability to organize drops in an indexed order so that the user knows which Drop to visit first. Much like a golf game, there is a “tee off” first drop and then an order by which the user is encouraged to travel.

Another differentiation is that drops can have an “unwrapping” moment where the user doesn't know what is at the drop until they are at the precise location. Then the drop reveals itself.

Another type of trigger may be a dependency on collecting other drops first. For example the user is not able to see Drop 2 until they've visited Drop 1.

Another type of trigger may be the number of users physically at the drop whereby the Drop does not unlock until a group of people are in its presence

Another type of trigger may be the “social influence” of the drop, meaning that it's locked until the certain number of “online impressions” are made.

Another type of trigger may be a physical Q/R code where the user must verify their location by taking a picture of a Q/R code present at that location.

In certain embodiments herein is the characteristic of user generated content, rather than content that is specifically chosen by an individual user for himself, or that is pre-selected or pre-filtered by criteria such as type of music, genre or the like. Another differentiation in certain embodiments herein the ability to remotely create a drop from a desktop.

In certain embodiments herein is that in certain known systems, a user is allowed to adjust his location and control the distance from a point. However, in certain embodiments herein the user is not allowed to adjust his location. This can have a marked effect on the user experience because if a user can query a broad distance, the music returned is not related to their immediate location. This would permit a user to select and listen to music that is not in that immediate location. In certain embodiments herein, the user cannot listen to music unless he within close proximity of where the music was dropped and intended to be heard.

In certain embodiments herein is the concept of Sponsored drops. Consider sponsored drops a form of location based advertising. For example, a business such as a coffee shop can reward customers as a particular location with a new featured artist. Rather than a user creating the Drop, a Brand “Sponsor” is creating the Drop. The Brand with access to a Content Management System in accordance with certain embodiments herein to create drops remotely.

Although the present technology has been described in relation to particular embodiments thereof, these embodiments and examples are merely exemplary and not intended to be limiting. It will be apparent to one of ordinary skill in the art that aspects of the technology, as described above, may be implemented in many different forms of compositions, methods and systems, in the implementations illustrated in the present disclosure. The present technology should, therefore, not be limited by the specific disclosure herein, and can be embodied in other forms not explicitly described here, without departing from the spirit thereof.

What is claimed:

1. A method of linking an audio file to a location, comprising:
(a) creating, through a computer server, a record of a first user's presence in the location; and
(b) associating, through the computer server, the audio file with the location and the first user's identification to create a point,
wherein access to the point is available to a second user when the second user is within a certain distance of the location.

2. The method of claim 1, further comprising:
(c) grouping the audio file with one or more additional audio files to create a set.

3. A music sharing system comprising:
(a) a processor configured to record information about a location and identity of a first user, and to associate the information and identity with an audio file selected by the user to link to the location; and
(b) a memory in communication with the processor and configured to store the information of (a),
wherein the information can be accessed by a second user when the second user is within a certain distance of the location.

4. The music sharing system of claim 3, further comprising:
(c) a display accessible by the second user, that shows the al information and identity of the first user in a graphical format.

5. The music sharing system of claim 3, wherein the first user accesses the processor through a desktop computer or a handheld device.

6. The music sharing system of claim 5, wherein the first user accesses the processor through a desktop computer, and the second user accesses the information through a handheld device.
